(19) United States
(12) Patent Application Publication
(10) Pub. No.: US 2002/0085970 A1
(43) Pub. Date: Jul. 4, 2002

(54) Shell and tube reactor

(75) Inventors: Richard A. Sederquist, Middletown, CT (US); Kevin Marchand, Burnaby (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby (CA)

(21) Appl. No.: 09/955,588

(22) Filed: Sep. 18, 2001

Related U.S. Application Data
(63) Continuation-in-part of application No. 09/752,792, filed on Dec. 28, 2000.

(51) Int. Cl. B01J 8/00; F28D 7/00

(52) U.S. Cl. 422/201; 422/196; 422/197; 422/211

(57) ABSTRACT

A fuel processing reactor is provided, comprising a shift catalyst bed disposed in a shell and tube reactor. The thermal stress on the present reactor during normal operation is reduced by cooling/heating both the shell and the tubes in the reactor. The present reactor may further comprise other beds such as hydrodesulfurizer catalyst beds, metal oxide beds, or sulfur polisher beds.

### BACKGROUND OF THE INVENTION

1. Field of the Invention

The present invention relates to shell and tube reactors for fuel processing systems, particularly shell and tube reactors having fixed tubes and comprising a shift catalyst bed.

2. Description of the Related Art

Fuel cell electric power generation systems require a source of hydrogen in order to generate electrical power. Fuel processing systems are employed to produce hydrogen when a hydrocarbon fuel is employed. Typically, the hydrocarbon fuel is directed to a reformer where it is catalytically reacted to form a reformate gas containing hydrogen.

Many hydrocarbon fuels contain organic sulfur compounds. Pipeline natural gas, for example, contains added odorants such as mercaptans and tetrahydrothiophene, as well as trace amounts of other organic sulfur compounds such as sulfides, disulfides and COS. These sulfur-containing compounds are typically removed from the fuel before reforming, since reforming catalysts are easily poisoned by sulfur. For example, the fuel may be subjected to a hydrodesulfurization process wherein the organic sulfur compounds are converted into inorganic compounds (primarily H₂S) over a hydrodesulfurization catalyst in the presence of hydrogen, which are removed in a metal oxide bed.

After reforming, the reformate typically contains unacceptably high levels of carbon monoxide (CO). Thus, most fuel processing systems also include a separate shift converter, where CO is catalytically converted to carbon dioxide, and a separate heat exchanger to control the temperature of the gas stream entering the shift converter. Such systems tend to be relatively large and complex.

An approach to reducing the size and complexity of fuel processing systems is to combine more than one catalyst bed into a single vessel, often referred to as a low temperature assembly. For example, U.S. Pat. No. 5,769,909 describes a fuel gas stream hydrodesulfurizer assembly which is thermally coupled with process gas heat exchangers and a shift converter. The reactor described employs an inner shift converter portion and an annular hydrodesulfurizer portion, with a plate coil and a compound heat exchange coil to maintain the heat exchange relationship between the components of the reactor. It will be appreciated that this assembly is relatively complex and costly to manufacture.

Shell and tube reactors have been employed for reformers and other components in fuel processing systems, and are a relatively simple and cost-effective design. In typical shell and tube configurations, indirect heat exchange with a circulating heat exchange fluid is used to maintain the catalytic beds at suitable operating temperatures. However, the thermal stresses placed on the shell and tubes during operation as a result of temperature difference between them during operation poses a significant problem—there is a risk of cracking or breakage of the shell and/or tubes due to differential expansion and contraction of the reactor components if the tubes are fixed to tubesheets and/or to the shell.

One approach to the problem of thermal stress has been to employ floating tube/tubesheet designs incorporating bellows, expansion joints, and the like, that allow for movement of the tubes within the shell. However, this approach introduces undesirable complexity and cost to the manufacture of such shell and tube reactors.

It would be desirable to provide a reactor for fuel processing systems which is simpler and more cost-effective to manufacture, and addresses the problem of thermal stress during operation.

### BRIEF SUMMARY OF THE INVENTION

A fuel processing reactor is provided, comprising a shift catalyst bed disposed in a shell and tube reactor. The thermal stress on the reactor during normal operation is reduced by cooling/heating both the shell and the tubes in the reactor.

In one embodiment, the reactor comprises:

a vessel comprising a heat exchange fluid inlet and a heat exchange fluid outlet;

a shell disposed within the vessel, at least a portion of the shell being spaced apart from the interior wall of the vessel, the shell comprising:

a first process gas inlet and a first process gas outlet, each extending through the vessel and fluidly isolated therefrom; and

a second process gas inlet and a second process gas outlet, each extending through the vessel and fluidly isolated therefrom;

a shift catalyst bed disposed in the shell and in fluid communication with the first process gas inlet and first process gas outlet;

a second bed disposed in the shell downstream of the shift catalyst bed and in fluid communication with the second process gas inlet and second process gas outlet; and

a plurality of tubes disposed within the shell and fixed thereto, each of the tubes extending through at least one of the shift catalyst bed and second bed, wherein the tubes and the space between the shell and the interior wall of the vessel form passageways for fluid flow between the heat exchange fluid inlet and heat exchange fluid outlet.

In another embodiment, the reactor comprises:

a vessel comprising a heat exchange fluid inlet and a heat exchange fluid outlet;

a first shell disposed within the vessel, at least a portion of the first shell being spaced apart from the interior wall of the vessel, the first shell comprising a first process gas inlet and a first process gas outlet, each extending through the vessel and fluidly isolated therefrom;

a shift catalyst bed disposed in the first shell and in fluid communication with the process gas inlet and process gas outlet;

a first plurality of tubes disposed within the first shell and fixed thereto, each of the tubes extending through the shift catalyst bed;

a second shell disposed within the vessel, at least a portion of the second shell being spaced apart from the interior wall of the vessel, the second shell comprising a second process gas inlet and a second process gas outlet, each extending through the vessel and fluidly isolated therefrom;

a second bed disposed in the second shell and in fluid communication with the second process gas inlet and second process gas outlet; and

a second plurality of tubes disposed within the second shell and fixed thereto, each of the tubes extending through the second bed, wherein the tubes, and the spaces between the first and second shells and the interior wall of the vessel, form passageways for fluid flow between the heat exchange fluid inlet and heat exchange fluid outlet.

In a further embodiment, the reactor comprises:

a vessel comprising a heat exchange fluid inlet and a heat exchange fluid outlet;

a shell disposed within the vessel, at least a portion of the shell being spaced apart from the vessel, the shell comprising a process gas inlet and a process gas outlet, each extending through the vessel and fluidly isolated therefrom;

a shift catalyst bed disposed in the shell and in fluid communication with the process gas inlet and process gas outlet; and

a plurality of tubes disposed within the shell and fixed thereto, each of the tubes extending through the shift catalyst bed, wherein the tubes and the space between the shell and the interior wall of the vessel form passageways for fluid flow between the heat exchange fluid inlet and heat exchange fluid outlet.

### BRIEF DESCRIPTION OF THE SEVERAL VIEWS OF THE DRAWINGS

FIGS. 1-4 are schematic representations in cross-section of certain embodiments of the present fuel processing reactor.

### DETAILED DESCRIPTION OF PREFERRED EMBODIMENTS

Thermal stresses can arise from the non-uniform heating/cooling of the shell and tubes of a reactor, or from the uniform heating of the reactor where the shell and tubes are not the same material. The thermal stress, σ, is given by the equation:

σ=EαΔT

where E=Young's modulus of elasticity;

α=coefficient of thermal expansion;

ΔT=temperature difference between the shell and tube.

All else being equal, the thermal stress on the reactor components between the shell and tube(s) is directly related to the magnitude of the temperature difference. In the present context, temperature difference means the radial temperature difference of any portion of the shell and tube assembly. A temperature gradient is often desirable along the axis of the assembly. Conventional reactors employ floating-tube designs to deal with the thermal stress during start-up and shutdown, as well as normal operation. However, expansion joints and bellows undesirably add complexity and cost to the manufacture of such reactors.

The present reactor employs heating/cooling of both the shell and the tubes so as to reduce the radial temperature difference between them, thus reducing thermal stress. By reducing the radial temperature difference between the shell and tubes, the thermal stresses on the present reactor can be reduced to the point where the tubes can be fixed to the shell, such as by welding to tubesheets, at a considerable reduction in cost relative to a conventional reactor of the same size.

The present reactor is contemplated for use in fuel processing systems in the production of hydrogen or syngas, for example, from a hydrocarbon fuel. Such systems typically employ a reformer to convert the fuel to a reformats stream comprising hydrogen. The reactor receives a process gas stream that may be the hydrocarbon fuel stream, reformate, or the output of other fuel processing components. The reactor is particularly suited to applications where the duty cycle of the fuel processing system is relatively short, requiring frequent start-ups and shutdowns. Fuel cell electric power generation systems for transportation or stand-by power are examples of such applications.

As used herein and in the appended claims, reference to shift catalysts includes low-temperature and high-temperature shift catalysts. High-temperature shift catalysts include Fe₃O₄/Cr₂O₃ and Fe₃O₄/Cr₂O₃/CuO catalyst compositions, and typically operate at temperatures between about 300° C. and about 450° C. Low-temperature shift catalysts include Cu/ZnO/Al₂O₃ catalyst compositions, and bifunctional catalysts developed by Argonne National Laboratory (Argonne, Ill., USA) incorporating bimetallic/polymetallic oxide compositions. (See, for example, Myers et al., “Alternative Water-Gas Shift Catalyst Development,” in Transportation Fuel Cell Power Systems 2000 Annual Progress Report, by U.S. Department of Energy, Washington, D.C., U.S. Department of Energy, October 2000.) Low-temperature shift catalysts typically operate at temperatures between about 180° C. and about 270° C.

The present reactor may further comprise a hydrodesulfurizer catalyst bed for converting organic sulfur compounds present in the process gas to inorganic sulfur compounds, primarily H₂S. Such catalysts include compositions comprising nickel oxide and/or molybdenum oxide, having a normal operating temperature range of about 300° C. to about 400° C. The particular hydrodesulfurizer catalyst employed in the present reactor, if any, is not essential and persons skilled in the art can readily choose a suitable catalyst composition for a given application.

The present reactor may also further include a metal oxide bed for removing H₂S from the process gas stream, either in place of, or in addition to, the hydrodesulfurizer catalyst bed. Suitable metal oxide beds comprise zinc oxide and/or zinc-containing mixed metal oxides, which operate at temperatures between about 300° C. and about 400° C. A reduced base metal absorbent bed, also known as a sulfur polisher, may also be employed to further reduce the concentration of H₂S in the process gas stream exiting the metal oxide bed. For example, sulfur polishers comprising Cu—Zn compositions and operating at temperatures between about 225° C. and about 400° C. may be suitable, and are available under the tradename PURASPEC 2084 from Synetix (Billingham, UK). Again, the particular metal oxide bed or sulfur polisher bed employed in the present reactor, if any, is not essential and persons skilled in the art can readily choose suitable such beds for a given application.

Suitable catalyst bed structures include particulate catalyst components and monoliths. For example, suitable catalyst bed structures include catalyst components disposed on a pelletized porous support, or disposed on a monolithic porous support, such as ceramic sponge or expanded metal foam, for instance, which allows for radial or lateral transfer of heat between the bed and heat exchange fluid. The catalyst bed(s) may be unsupported, as in the case of monoliths, or supported within the shell by conventional means such as screens, perforated plate, or tubesheets, for example. Persons skilled in the art may readily determine suitable catalyst bed structures and supports for a given application.

References to upstream or downstream components of the present reactor refer to the position of the component relative to the flow of heat exchange fluid within the reactor.

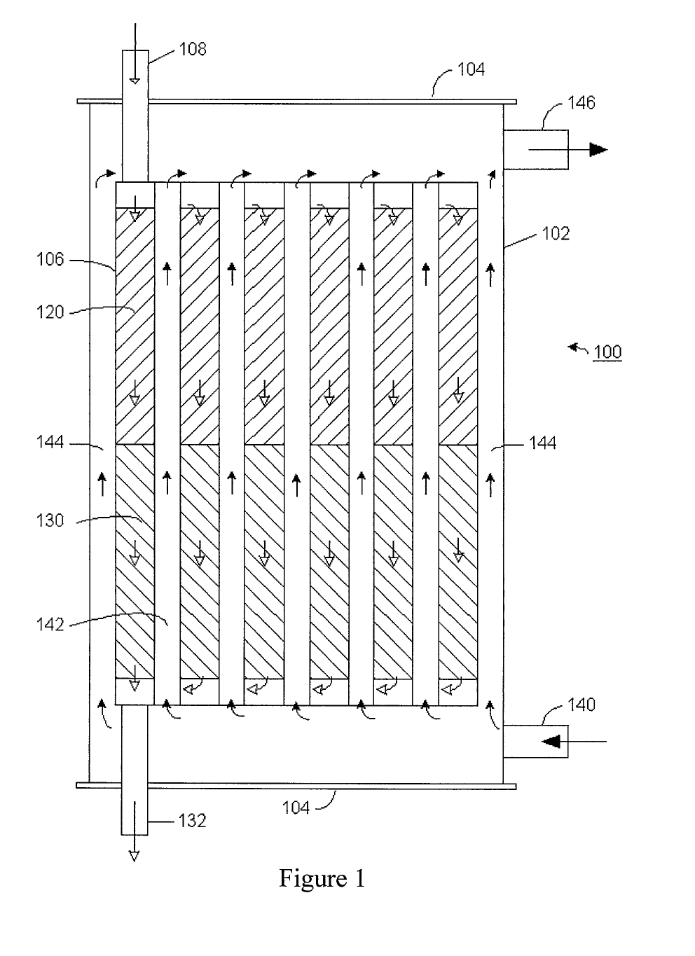

FIG. 1 is a schematic representation of an embodiment of the present fuel processing reactor. Assembly 100 comprises vessel 102 having end plates 104. To facilitate servicing of the reactor, either or both of endplates 104 may be removable. Shell 106 is disposed within vessel 102.

During normal operation, a process gas comprising hydrogen, carbon monoxide and water is directed via process gas inlet 108 to high-temperature shift catalyst bed 120, where carbon monoxide present is converted to carbon dioxide via the water-gas shift reaction. Process gas exiting catalyst bed 120 is then directed to low-temperature shift catalyst bed 130, where the concentration of carbon monoxide in the process gas is further reduced. Process gas exiting catalyst bed 130 is directed out of assembly 100 via process gas outlet 132.

Heat exchange fluid is introduced into vessel 102 via heat exchange fluid inlet 140. The heat exchange fluid then flows through tubes 142 and space 144 between vessel 102 and shell 108, exiting via heat exchange fluid outlet 146. On start-up a heat exchange fluid could be circulated within vessel 102 to assist heating of the catalyst bed(s) in shell 106 to normal operating temperature.

During normal operation, shift catalyst beds 130 and 120 are cooled by the heat exchange fluid flowing through vessel 102. Of course, upstream catalyst bed 130 is cooled to a lower temperature than downstream catalyst bed 120 as heat exchange fluid flows between fluid inlet 140 and fluid outlet 146. This assists in maintaining both catalyst beds within their normal operating temperature ranges. Also, since a portion of the shift reaction occurs in catalyst bed 120, the amount of heat generated in catalyst bed 130 may be lower because of the lower concentration of CO in the process gas stream. This, in turn, may reduce the cooling requirements of catalyst bed 130 and further assist in maintaining both catalyst beds within their normal operating temperature ranges.

The process gas entering assembly 100 should be substantially free of sulfur, as the low-temperature shift catalyst is poisoned by sulfur. However, other embodiments of the present reactor may also be employed with process gas streams containing sulfur compounds.

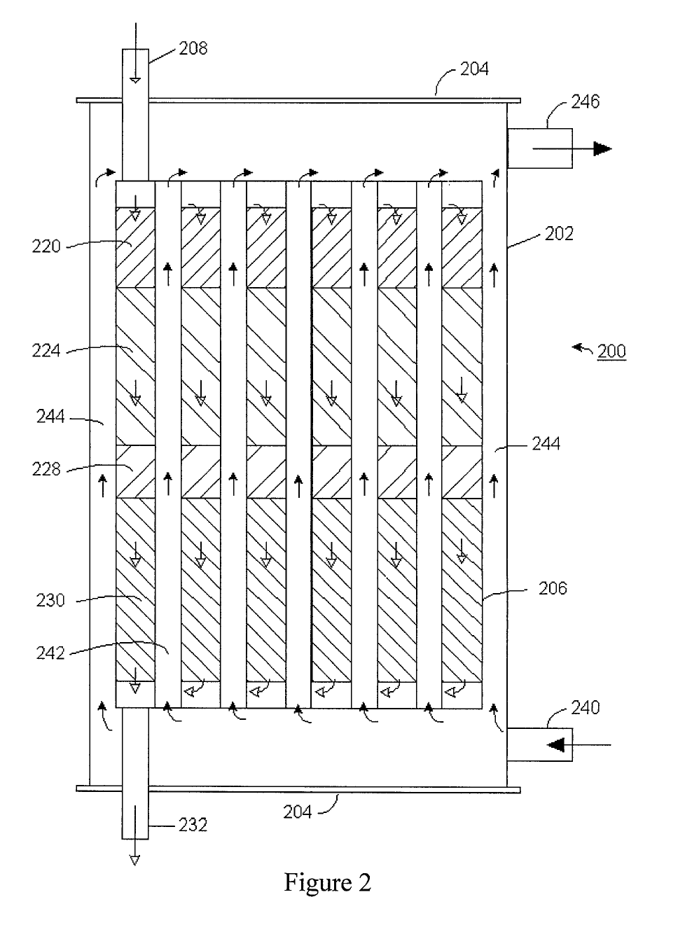

FIG. 2 is a schematic representation of another embodiment of the present fuel processing reactor. Assembly 200 comprises vessel 202 with optionally removable endplates 204. Shell 206 is disposed within vessel 202.

During normal operation, a process gas stream comprising hydrogen, CO, water, and H₂S is provided via process gas inlet 208 to optional high-temperature shift catalyst bed 220, where carbon monoxide present is converted to carbon dioxide via the water-gas shift reaction.

The process gas stream is then introduced into metal oxide bed 224, where a substantial portion of the H₂S present is removed. The process gas stream is then directed into optional bed 228 where substantially the remainder of H₂S in the process gas stream is removed. Bed 228 may comprise a sacrificial shift catalyst or a sulfur polisher bed.

After exiting bed 228, the process gas is then introduced to low-temperature shift catalyst bed 230, where the concentration of carbon monoxide in the process gas is further reduced. The process gas then exits assembly 200 via process gas outlet 232.

Heat exchange fluid is introduced into vessel 202 via heat exchange fluid inlet 240. The heat exchange fluid then flows through tubes 242 and space 244 between vessel 202 and shell 206, exiting via heat exchange fluid outlet 246. On start-up a heated fluid could be circulated within vessel 202 to assist heating of the catalyst beds to normal operating temperature.

During normal operation, shift catalyst bed 230 is cooled by the heat exchange fluid flowing through vessel 202, which assists in maintaining shift catalyst bed 230 within its normal operating temperature range.

As the heat exchange fluid flows through vessel 202 it removes heat from the metal oxide bed 224. The flow of heat exchange fluid through vessel 202 results in a temperature gradient, with the process gas exit portion of metal oxide bed 224 being significantly cooler than the process gas inlet portion of the bed. Higher temperatures are advantageous for the absorbent capacity of the bed. Lower temperatures are advantageous for the H₂S absorption equilibrium. Thus, the temperature profile in metal oxide bed 224 may be controlled to increase the H₂S capacity of the process gas inlet portion of the bed and shift the equilibrium in the process gas exit portion towards increased H₂S absorption, and may increase the ability of metal oxide bed 224 to remove sulfur from the process gas stream, relative to a more isothermal metal oxide bed.

Further, where the present reactor comprises high-temperature shift catalyst bed 220, a portion of the shift reaction occurs therein, generating heat. This heat may then be transferred to the front portion of metal oxide bed 224, thereby assisting in establishing the temperature gradient through it, as described above. The increased heat may also result in a higher temperature difference between the catalyst beds and the heat exchange fluid flowing through the present reactor, and thus may increase the efficiency of heat exchange. Also, since a portion of the shift reaction occurs in the high-temperature shift catalyst bed, the cooling requirements of shift catalyst bed 230 may be reduced for the reasons described above in relation to apparatus 100 of FIG. 1.

In addition, the metal oxide bed may increase the overall heat transfer coefficient of the shell and tube assembly as the process gas stream flows through the metal oxide bed, relative to, for example, a conventional shell and tube heat exchanger having an empty shell. In other words, the process gas stream may be more efficiently cooled to a temperature suitable for introduction to the upstream shift catalyst bed. Thus, the present reactor may provide for more efficient heat exchange as compared to similar, separate components.

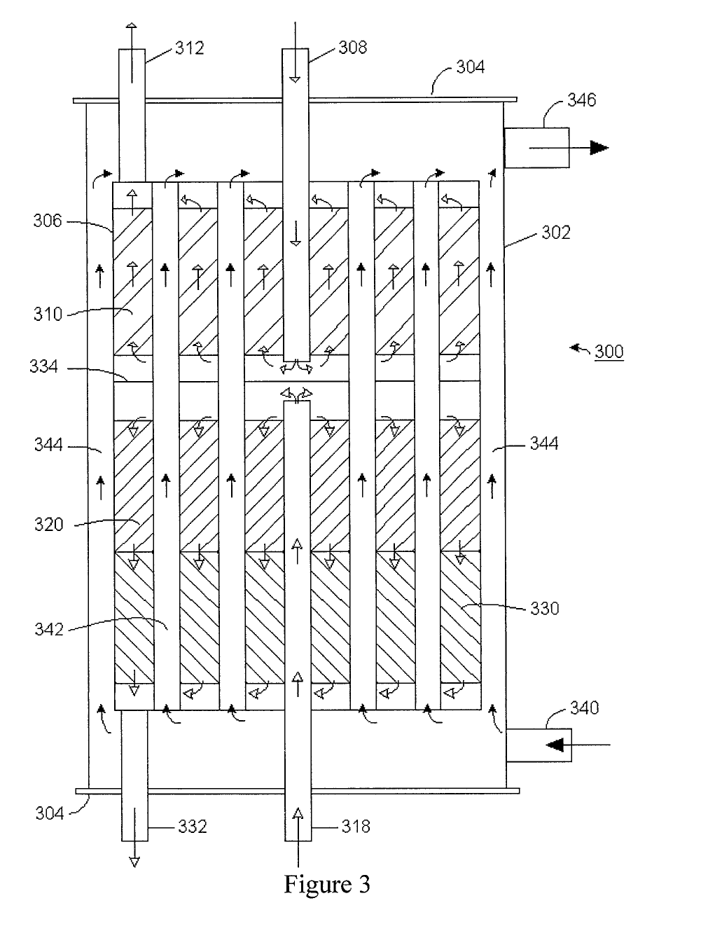

FIG. 3 is a schematic representation of another embodiment of the present fuel processing reactor. Assembly 300 comprises vessel 302 with optionally removable endplates 304. Shell 306 is disposed within vessel 302.

During normal operation, a sulfur-containing fuel gas stream is provided via fuel inlet 308 to hydrodesulfurization catalyst bed 310. The organic sulfur compounds in the fuel are converted into inorganic sulfur compounds (primarily hydrogen sulfide) in catalyst bed 310, and the H₂S-containing fuel gas stream exits assembly 300 via fuel outlet 312.

The H₂S in the fuel gas stream may then removed be in a downstream component, such as a metal oxide bed, for example. Alternatively, assembly 300 may further comprise a metal oxide bed disposed within shell 306 and fluidly connected to catalyst bed 310. The choice of placing a metal oxide bed in assembly 300 will depend on such factors as the concentration of organic sulfur compounds in the fuel and the size of the metal oxide bed.

In a fuel processing system, the desulfurized fuel would then be supplied to a reformer where it is catalytically reacted to form a process gas containing hydrogen, carbon dioxide, carbon monoxide and water.

Process gas is directed via process gas inlet 318 to high-temperature shift catalyst bed 320, where carbon monoxide present is converted to carbon dioxide via the water-gas shift reaction. Process gas exiting catalyst bed 320 is then directed to low-temperature shift catalyst bed 330, where the concentration of carbon monoxide in the process gas is further reduced. Process gas exiting catalyst bed 330 is directed out of assembly 300 via process gas outlet 332. As shown in FIG. 3, plate 334 separates the fuel gas and process gas streams from each other.

Heat exchange fluid is introduced into vessel 302 via heat exchange fluid inlet 340. The heat exchange fluid then flows through tubes 342 and space 344 between vessel 302 and shell 306, exiting via heat exchange fluid outlet 346. On start-up a heated fluid could be circulated within vessel 302 to assist heating of the catalyst beds to normal operating temperature.

During normal operation, the flow of heat exchange fluid assists in maintaining shift catalyst beds 330 and 320 within their normal operating temperature ranges, in the same manner as assembly 100 in FIG. 1. The heat generated by shift catalyst beds 330 and 320 is then transferred to hydrodesulfurization catalyst bed 310 by the heat exchange fluid, assisting in maintaining the catalyst within its normal operating temperature range. Thus, the flow of heat exchange fluid through vessel 302 develops a temperature gradient that assists in maintaining shift catalyst beds 330, 320 and catalyst bed 310 at suitable operating temperatures.

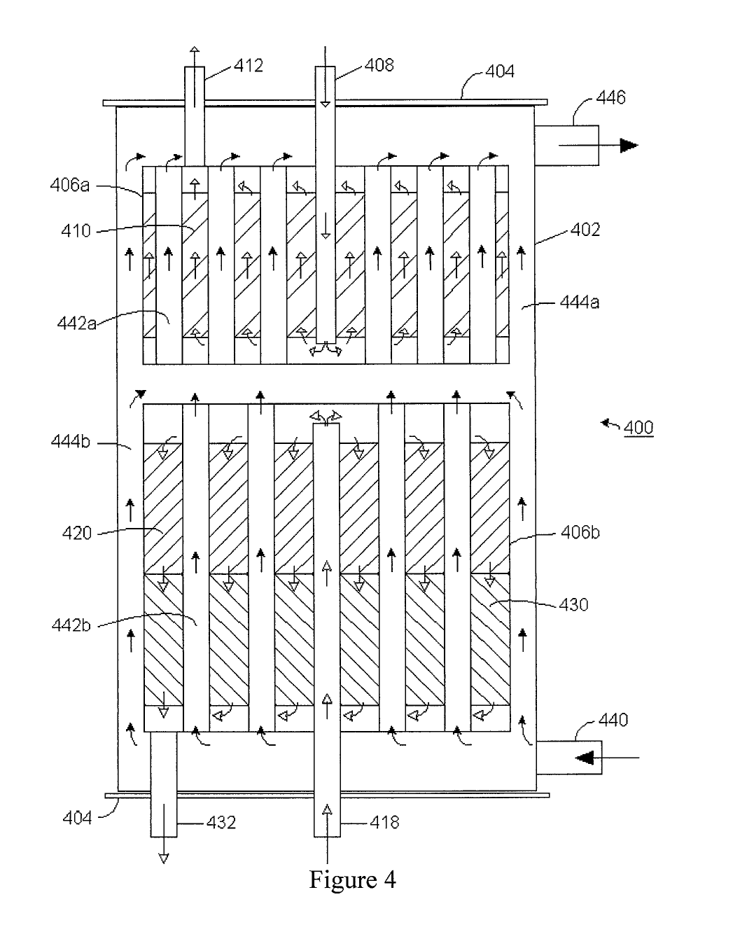

FIG. 4 is a schematic representation of another embodiment of the present fuel processing reactor. Features of reactor 400 similar to those of reactor 300 in FIG. 3 are given similar numbers.

During normal operation, a sulfur-containing fuel gas stream is provided to hydrodesulfurization catalyst bed 410 via fuel inlet 408 and the H₂S-containing fuel gas stream is exhausted via fuel outlet 412. Heat exchange fluid flows through tubes 442a and space 444a between vessel 402 and shell 406a.

Similarly, process gas is supplied to high-temperature shift catalyst bed 320 and low-temperature shift catalyst bed 430 via process gas inlet 418, and is exhausted via process gas outlet 432. Heat exchange fluid also flows through tubes 442b and space 444b between vessel 402 and shell 406b.

In all other material respects, reactor 400 functions in the same manner as reactor 300 in FIG. 3, discussed above. By having separate shells it is possible to independently vary the number of tubes of each shell. Thus, the number of tubes may be selected to provide different heat exchange characteristics for each shell and tube assembly, if desired.

Alternatively, a single shell could be employed in reactor 400 that provides a plenum between tubes 442a and 442b that would be fluidly isolated from the beds of the present assembly. Heat exchange fluid would flow from tubes 442b to the plenum for distribution through tubes 442a. Tubes could also be present extending through the length of the shell.

While the embodiments of the present reactor illustrated in FIGS. 1, 3 and 4, are shown having a shift catalyst bed comprising a high-temperature and low-temperature shift catalyst, it will be appreciated that a shift catalyst bed comprising either shift catalyst may be employed. The choice of shift catalyst(s) employed in the present reactor will depend on such factors as the temperature and flow rate of the incoming process gas stream(s), the temperature, flow rate, and heat capacity of the heat exchange fluid, and the desired ratio of CO to hydrogen in the process gas exiting the present reactor. Similar factors will also affect the choice of other beds present, if any, in the present reactor. Persons skilled in the art may readily determine a suitable selection of catalyst bed(s) in the present reformer for a given fuel processing application.

The choice of heat exchange fluid is not essential to the present reactor, and any suitable heat exchange fluid may be employed, such as air, burner exhaust from associated fuel processing components, water or thermal oil, for example. Where the present reactor is part of a fuel cell electric power generation system, suitable heat exchange fluids further include anode or cathode exhaust streams.

The shell in the present reactor may be circular in cross-section or it may have other suitable shapes. It may be located as desired within the vessel, provided that at least a portion of the shell is spaced away for the interior wall of the vessel to provide a passage for the flow of heat exchange fluid over the surface of the shell. For example, the present reactor may conveniently comprise a cylindrical shell centrally located within a cylindrical vessel and providing for an annular fluid flow passage over the surface of the shell. If desired, the vessel containing the shell may have projections on the inner wall that contact the shell and maintain it in position.

Similarly, the tubes of the present reactor may be of any cross-sectional shape, and they may vary in diameter, cross-sectional shape, and/or length. They may extend axially, radially, or in any other direction through the shell. Other heat exchange elements may also be employed in the present reactor, such as swirlers, fins or heat exchange plates. Such heat exchange elements could be incorporated into the tubes and/or the shell, as desired. For example, in embodiments including a high-temperature shift catalyst bed, the portions of the tubes extending through the bed may comprise swirlers or other features for increasing the local heat exchange coefficient of the tubes.

The present reactor may also comprise one or more insulation layers surrounding the vessel and/or on its interior wall. If desired, the vessel may have a removable end plate on one or both ends to facilitate servicing of the reactor.

To adequately reduce the radial temperature differential between the shell and tubes, several factors should be balanced in designing the present reactor for a given application. The number and position of the tubes may depend on the dimensions of the shell, as well as the size and composition of the catalyst bed(s). Similarly, the rate and distribution of flow of heat exchange fluid within the tubes and over the shell should be taken into account. The specific design parameters chosen, including an acceptable radial temperature differential, can readily be determined for a given application by persons skilled in the art.

The present reactor integrates a shift catalyst bed, optional additional catalyst/absorbent beds, and heat exchange elements into a single vessel, which may significantly reduce the size, complexity and/or cost of a fuel processing system. The present reactor may also increase the heat exchange efficiency of the integrated elements, relative to similar, separate components.

In addition, by flowing heat exchange fluid through the tubes and over the shell, it is possible to significantly reduce the radial temperature difference between them, thereby reducing the thermal stress. This, in turn, allows the tubes to be fixed to the shell in the present reactor, without the necessity of floating tubes or expansion joints. Thus, the present reactor provides for a simpler and more cost-effective design than conventional floating-tube designs.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications that incorporate those features coming within the scope of the invention.

What is claimed is:

1. A fuel processing reactor comprising:
a vessel comprising a heat exchange fluid inlet and a heat exchange fluid outlet;
a shell disposed within the vessel, at least a portion of the shell being spaced apart from the interior wall of the vessel, the shell comprising:
a first process gas inlet and a first process gas outlet, each extending through the vessel and fluidly isolated therefrom, and
a second process gas inlet and a second process gas outlet, each extending through the vessel and fluidly isolated therefrom;
a shift catalyst bed disposed in the shell and in fluid communication with the first process gas inlet and first process gas outlet;
a second bed disposed in the shell downstream of the shift catalyst bed and in fluid communication with the second process gas inlet and second process gas outlet; and
a plurality of tubes disposed within the shell and fixed thereto, each of the tubes extending through at least one of the shift catalyst bed and second bed, wherein the tubes and the space between the shell and the interior wall of the vessel form passageways for fluid flow between the heat exchange fluid inlet and heat exchange fluid outlet.

2. The reactor of claim 1 wherein the vessel further comprises removeably attachable end plates.

3. The reactor of claim 1 wherein the vessel is insulated.

4. The reactor of claim 1 wherein the fluid inlet is connectable to a cathode exhaust manifold of a fuel cell stack for supplying cathode exhaust to the vessel as a heat exchange fluid.

5. The reactor of claim 1 wherein the shell is disposed concentrically within the vessel.

6. The reactor of claim 5 wherein the space between shell and the interior wall of the vessel forms an annular passageway.

7. The reactor of claim 1, further comprising a plenum located in the shell between the shift catalyst bed and the second bed, and fluidly isolated therefrom, wherein a portion of the tubes extend from one end of the shell to the plenum through the shift catalyst bed, and another portion of the tubes extend from the other end of the shell to the plenum through the second bed.

8. The reactor of claim 1 wherein the shift catalyst bed comprises an upstream low-temperature shift catalyst bed and a downstream high-temperature shift catalyst bed.

9. The reactor of claim 8 wherein the portion of the tubes extending through the high-temperature shift catalyst bed comprise heat exchange elements.

10. The reactor of claim 9 wherein the heat exchange elements comprise swirlers.

11. The reactor of claim 1 wherein the second bed comprises a hydrodesulfurization catalyst bed

12. The reactor of claim 11 wherein the second bed further comprises a metal oxide bed in fluid communication with the hydrodesulfurization catalyst bed.

13. The reactor of claim 12 wherein the second bed further comprises a sulfur polisher bed in fluid communication with the metal oxide bed.

14. The reactor of claim 1 wherein the second bed comprises a metal oxide bed.

15. The reactor of claim 14 wherein the second bed further comprises a sulfur polisher bed in fluid communication with the metal oxide bed.

16. A fuel processing reactor comprising:
a vessel comprising a heat exchange fluid inlet and a heat exchange fluid outlet;
a first shell disposed within the vessel, at least a portion of the first shell being spaced apart from the interior wall of the vessel, the first shell comprising a first process gas inlet and a first process gas outlet, each extending through the vessel and fluidly isolated therefrom;
a shift catalyst bed disposed in the first shell and in fluid communication with the process gas inlet and process gas outlet;
a first plurality of tubes disposed within the first shell and fixed thereto, each of the tubes extending through the shift catalyst bed;
a second shell disposed within the vessel, at least a portion of the second shell being spaced apart from the interior wall of the vessel, the second shell comprising a second process gas inlet and a second process gas outlet, each extending through the vessel and fluidly isolated therefrom;
a second bed disposed in the second shell and in fluid communication with the second process gas inlet and second process gas outlet; and
a second plurality of tubes disposed within the second shell and fixed thereto, each of the tubes extending through the second bed, wherein the tubes, and the spaces between the first and second shells and the interior wall of the vessel, form passageways for fluid flow between the heat exchange fluid inlet and heat exchange fluid outlet.

17. The reactor of claim 16 wherein the vessel further comprises removeably attachable end plates.

18. The reactor of claim 16 wherein the vessel is insulated.

19. The reactor of claim 16 wherein the fluid inlet is connectable to a cathode exhaust manifold of a fuel cell stack for supplying cathode exhaust to the vessel as a heat exchange fluid.

20. The reactor of claim 16 wherein the first shell is disposed concentrically within the vessel.

21. The reactor of claim 20 wherein the space between first shell and the interior wall of the vessel forms an annular passageway.

22. The reactor of claim 16 wherein the second shell is disposed concentrically within the vessel.

23. The reactor of claim 22 wherein the space between second shell and the interior wall of the vessel forms an annular passageway.

24. The reactor of claim 16 wherein the shift catalyst bed comprises an upstream low-temperature shift catalyst bed and a downstream high-temperature shift catalyst bed.

25. The reactor of claim 24 wherein the portion of the tubes extending through the high-temperature shift catalyst bed comprise heat exchange elements.

26. The reactor of claim 25 wherein the heat exchange elements comprise swirlers.

27. The reactor of claim 16 wherein the second bed comprises a hydrodesulfurization catalyst bed.

28. The reactor of claim 27 wherein the second bed further comprises a metal oxide bed in fluid communication with the hydrodesulfurization catalyst bed.

29. The reactor of claim 28 wherein the second bed further comprises a sulfur polisher bed in fluid communication with the metal oxide bed.

30. The reactor of claim 16 wherein the second bed comprises a metal oxide bed.

31. The reactor of claim 30 wherein the second bed further comprises a sulfur polisher bed in fluid communication with the metal oxide bed.

32. A fuel processing reactor comprising:
a vessel comprising a heat exchange fluid inlet and a heat exchange fluid outlet;
a shell disposed within the vessel, at least a portion of the shell being spaced apart from the vessel, the shell comprising a process gas inlet and a process gas outlet, each extending through the vessel and fluidly isolated therefrom;
a shift catalyst bed disposed in the shell and in fluid communication with the process gas inlet and process gas outlet; and
a plurality of tubes disposed within the shell and fixed thereto, each of the tubes extending through the shift catalyst bed, wherein the tubes and the space between the shell and the interior wall of the vessel form passageways for fluid flow between the heat exchange fluid inlet and heat exchange fluid outlet.

33. The reactor of claim 32 wherein the vessel further comprises a removeably attachable end plate.

34. The reactor of claim 32 wherein the vessel is insulated.

35. The reactor of claim 32 wherein the fluid inlet is connectable to a cathode exhaust manifold of a fuel cell stack for supplying cathode exhaust to the vessel as a heat exchange fluid.

36. The reactor of claim 32 wherein the shell is disposed concentrically within the vessel.

37. The reactor of claim 36 wherein the space between shell and the interior wall of the vessel forms an annular passageway.

38. The reactor of claim 32, further comprising a metal oxide bed disposed in the shell between the shift catalyst bed and the process gas inlet.

39. The reactor of claim 38 wherein the metal oxide bed comprises zinc oxide.

40. The reactor of claim 38, further comprising a sulfur polisher bed disposed in the shell between the metal oxide bed and the low-temperature shift catalyst bed.

41. The reactor of claim 32 wherein the shift catalyst bed comprises an upstream low-temperature catalyst bed and a downstream high-temperature shift catalyst bed.

42. The reactor of claim 41, further comprising a metal oxide bed disposed in the shell between the low-temperature shift catalyst bed and the high-temperature shift catalyst bed.

43. The reactor of claim 42, further comprising a sulfur polisher bed disposed in the shell between the metal oxide bed and the low-temperature shift catalyst bed.
